(19) United States
(12) Patent Application Publication
(10) Pub. No.: US 2024/0371128 A1
(43) Pub. Date: Nov. 7, 2024

(54) INFORMATION PROCESSING DEVICE, INFORMATION PROCESSING METHOD, AND PROGRAM

(71) Applicant: Sony Group Corporation, Tokyo (JP)

(72) Inventor: Guifen TIAN, Kanagawa (JP)

(73) Assignee: Sony Group Corporation, Tokyo (JP)

(21) Appl. No.: 18/688,797

(22) PCT Filed: Feb. 21, 2022
(86) PCT No.: PCT/JP2022/006916

§ 371 Date: Mar. 4, 2024

(30) Foreign Application Priority Data
Sep. 15, 2021 (JP) 2021-150368

(51) Int. Cl. G06V 10/75; G06V 10/26; G06V 10/42; G06V 10/44; G06V 10/50; G06V 10/77; G06V 10/771; G06V 10/772; G06V 10/82; G06V 10/94; G06V 20/50

(52) U.S. Cl. CPC G06V 10/757; G06V 10/42; G06V 10/44; G06V 10/50; G06V 10/771; G06V 10/7715; G06V 10/945; G06V 20/50; G06V 10/26; G06V 10/772; G06V 10/82

(57) ABSTRACT

Accuracy in feature point matching is further improved. There is provided an information processing device including a matching integration unit that performs matching of a feature point detected from an input image, in which the matching integration unit performs the matching of the feature point on the basis of a local feature generated on the basis of a pixel of the feature point and pixels around the feature point and a global feature generated on the basis of entire pixels of the input image.

### TECHNICAL FIELD

The present disclosure relates to an information processing device, an information processing method, and a program.

### BACKGROUND ART

In recent years, techniques of detecting feature points from an image and matching the detected feature points have been developed. For example, Patent Document 1 discloses a technique of dividing an image into a road surface area and other areas and matching feature points on the basis of local features of feature points detected near the center of the road surface area.

### CITATION LIST

### Patent Document

Patent Document 1: Japanese Patent Application Laid-Open No. 2020-60899

### SUMMARY OF THE INVENTION

### Problems to be Solved by the Invention

However, the local features are greatly affected by a repetitive pattern present in the image, lighting environment and weather at the time of image shooting, and the like. Thus, the accuracy in the feature point matching based on the local features may not be stable.

### Solutions to Problems

According to an aspect of the present disclosure, there is provided an information processing device including a matching integration unit that performs matching of a feature point detected from an input image, in which the matching integration unit performs the matching of the feature point on the basis of a local feature generated on the basis of a pixel of the feature point and pixels around the feature point and a global feature generated on the basis of entire pixels of the input image.

Furthermore, according to another aspect of the present disclosure, there is provided an information processing method including performing, with a processor, matching of a feature point detected from an input image, in which the performing the matching further includes performing matching of the feature point on the basis of a local feature generated on the basis of a pixel of the feature point and pixels around the feature point and a global feature generated on the basis of entire pixels of the input image.

Furthermore, according to another aspect of the present disclosure, there is provided a program for causing a computer to function as an information processing device including a matching integration unit that performs matching of a feature point detected from an input image, in which the matching integration unit performs the matching of the feature point on the basis of a local feature generated on the basis of a pixel of the feature point and pixels around the feature point and a global feature generated on the basis of entire pixels of the input image.

### BRIEF DESCRIPTION OF DRAWINGS

FIG. 1 is a diagram for explaining an exemplary configuration of a system 1 according to an embodiment of the present disclosure.

FIG. 2 is a block diagram illustrating a first exemplary configuration of an information processing device 10 according to the present embodiment.

FIG. 3 is a block diagram illustrating a second exemplary configuration of the information processing device 10 according to the present embodiment.

FIG. 4 is a diagram for explaining image segmentation by a segmentation unit 130 according to the present embodiment.

FIG. 5 is a diagram for explaining depth estimation by a depth estimation unit 170 according to the present embodiment.

FIG. 6 is a flowchart for explaining a flow of automated selection of target feature points by a feature point selection unit 140 according to the present embodiment.

FIG. 7A is an example of an image spatial distribution histogram according to the present embodiment.

FIG. 7B is an example of the image spatial distribution histogram according to the present embodiment.

FIG. 8 is a diagram for explaining an effect of the feature point selection by the feature point selection unit 140 according to the present embodiment.

FIG. 9 is diagram for explaining target feature point selection by a user according to the present embodiment.

FIG. 10 is a diagram for explaining an outline of feature generation by a feature generation unit 150 according to the present embodiment.

FIG. 11 is a diagram for explaining global feature generation by the feature generation unit 150 according to the present embodiment.

FIG. 12 is a flowchart for explaining a flow of a dictionary generation phase according to the present embodiment.

FIG. 13 is a flowchart for explaining a flow of a matching phase according to the present embodiment.

FIG. 14 is a diagram for explaining multi-task learning according to the present embodiment.

FIG. 15 is a diagram for explaining a flow of the multi-task learning according to the present embodiment.

FIG. 16 is a flowchart for explaining a flow of target feature point matching based on the multi-task learning according to the present embodiment.

FIG. 17 is a block diagram illustrating exemplary hardware configuration of an information processing device 90 according to the present embodiment.

### MODE FOR CARRYING OUT THE INVENTION

Hereinafter, a preferred embodiment of the present disclosure will be described in detail with reference to the accompanying drawings. Note that, in the present specification and drawings, components having substantially the same functional configurations are denoted by the same reference signs, and redundant explanations will be omitted.

Note that the description will be given in the following order.
1. Embodiment
1.1. Overview
1.2. Exemplary system configuration
1.3. Exemplary configuration of information processing device 10
1.4. Functional details
2. Exemplary hardware configuration
3. Conclusion

### 1. Embodiment

### 1.1. Overview

First, an overview of the present disclosure will be described.

As described above, in recent years, techniques of detecting feature points from an image and matching the detected feature points have been developed.

As an example, it is possible to generate a local feature from a pixel of a feature point detected in an image and pixels around the feature point, and to perform feature point matching on the basis of the local feature.

However, the local features are greatly affected by a repetitive pattern present in the image, lighting environment and weather at the time of image shooting, and the like.

For example, in a case where a repetitive pattern is present in the image, there is a possibility that a pair of originally different feature points is erroneously recognized as a pair of the same feature points.

Furthermore, in a case where there is a shadow or the like due to an influence of weather or the like at the time of image shooting, for example, there is a possibility that even a pair of originally the same feature points is erroneously recognized as a pair of different feature points.

The technical idea according to an embodiment of the present disclosure has been conceived with a focus on the points described above, and is to further improve accuracy in feature point matching.

For that purpose, one of characteristics of an information processing method according to an embodiment of the present disclosure is that feature point matching is performed on the basis of a global feature generated on the basis of entire pixels of an input image in addition to a local feature.

With this arrangement, it becomes possible to effectively reduce an influence of a repetitive pattern, lighting environment, weather, and the like, and to achieve more accurate feature point matching.

Hereinafter, a configuration for implementing an information processing method according to an embodiment of the present disclosure will be described.

### 1.2. Exemplary System Configuration

First, an exemplary configuration of a system 1 according to an embodiment of the present disclosure will be described.

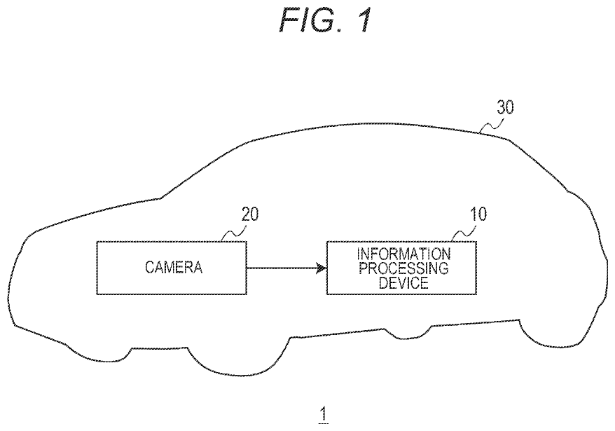

FIG. 1 is a diagram for explaining an exemplary configuration of the system 1 according to the embodiment of the present disclosure.

As illustrated in FIG. 1, the system 1 according to the present embodiment includes an information processing device 10 and a camera 20 installed in a mobile object 30.

### (Information Processing Device 10)

The information processing device 10 according to the present embodiment is a device that matches feature points detected from an input image.

In addition, one of characteristics of the information processing device 10 according to the present embodiment is that the feature point matching is performed on the basis of a local feature generated on the basis of a pixel of a feature point and pixels around the feature point and a global feature generated on the basis of the entire pixels of the input image.

A detailed configuration example of the information processing device 10 according to the present embodiment will be separately described.

### (Camera 20)

The camera 20 according to the present embodiment captures an RGB image.

The RGB image captured by the camera 20 is input to the information processing device 10.

### (Mobile Object 30)

The mobile object 30 according to the present embodiment may be a device that moves by an operation performed by a user, or may be a device that moves autonomously.

The mobile object 30 according to the present embodiment may be, for example, a vehicle, a drone, an autonomous mobile robot, or the like.

A result of the feature point matching by the information processing device 10 may be used for calibration of the camera 20, for example.

Improvement in the feature point matching accuracy directly leads to improvement in the calibration accuracy of the camera 20.

Furthermore, as the calibration accuracy of the camera 20 improves, the accuracy in three-dimensional reconstruction, simultaneous localization and mapping (SLAM), and the like of obtained information also improves.

As a result thereof, it becomes possible to significantly improve the performance of the mobile object 30 that utilizes the techniques as described above.

The exemplary configuration of the system 1 according to the present embodiment has been described above. Note that the configuration described above with reference to FIG. 1 is merely an example, and the configuration of the system 1 according to the present embodiment is not limited to such an example.

The system 1 according to the present embodiment may further include a device that executes processing such as the three-dimensional reconstruction, SLAM, and the like of information, for example.

The configuration of the system 1 according to the present embodiment may be flexibly modified depending on specifications and operations.

### 1.3. Exemplary Configuration of Information Processing Device 10

Next, an exemplary configuration of the information processing device 10 according to the present embodiment will be described.

First, a first exemplary configuration of the information processing device 10 according to the present embodiment will be described.

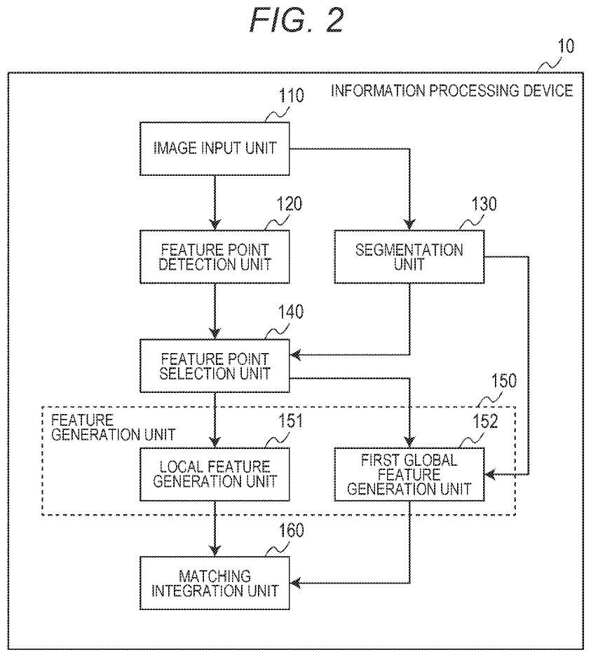

FIG. 2 is a block diagram illustrating the first exemplary configuration of the information processing device 10 according to the present embodiment.

As illustrated in FIG. 2, the information processing device 10 according to the present embodiment may include an image input unit 110, a feature point detection unit 120, a segmentation unit 130, a feature point selection unit 140, a feature generation unit 150, and a matching integration unit 160.

### (Image Input Unit 110)

The image input unit 110 according to the present embodiment inputs an image captured by the camera 20 to the feature point detection unit 120 and the like.

Hereinafter, an image input from the image input unit 110 to another component will be referred to as an input image.

### (Feature Point Detection Unit 120)

The feature point detection unit 120 according to the present embodiment detects, as a feature point, a pixel having a feature different from that of peripheral pixels from the input image.

For example, the feature point detection unit 120 may detect a feature point using a technique such as a scale-invariant feature transform (SIFT), Harris corner, or the like.

In this case, the feature point detection unit 120 often detects, as a feature point, a pixel of a corner point, a portion having a strong edge, or the like in the input image.

### (Segmentation Unit 130)

The segmentation unit 130 according to the present embodiment performs image segmentation on the input image.

The image segmentation is an exemplary process of generating a global feature according to the present embodiment.

The global feature according to the present embodiment may include a first global feature generated on the basis of a result of the image segmentation performed on the input image.

The image segmentation according to the present embodiment may be multiclass segmentation using a neural network including an encoder and a decoder.

Details of the image segmentation according to the present embodiment will be separately described.

### (Feature Point Selection Unit 140)

The feature point selection unit 140 according to the present embodiment selects a feature point (which may be referred to as a target feature point) to be subject to matching from among a plurality of feature points detected by the feature point detection unit 120.

One of characteristics of the feature point selection unit 140 according to the present embodiment is that the target feature point is selected from among the feature points detected in a still image region determined as a stationary object.

Furthermore, the feature point selection unit 140 according to the present embodiment may select the target feature point on the basis of spatial distribution of the feature points.

Details of the target feature point selection according to the present embodiment will be separately described.

### (Feature Generation Unit 150)

The feature generation unit 150 according to the present embodiment generates a feature used for the feature point matching performed by the matching integration unit 160.

The feature described above includes a local feature based on a pixel of a feature point and pixels around the feature point, and a global feature based on the entire pixels of the input image.

As described above, the global feature according to the present embodiment may include the first global feature based on the result of the image segmentation performed on the input image.

The feature generation unit 150 according to the present embodiment may include a sub-component that generates a local feature or each global feature.

In the case of the example illustrated in FIG. 2, the feature generation unit 150 includes a local feature generation unit 151 that generates a local feature and a first global feature generation unit 152 that generates a first global feature.

The feature generation according to the present embodiment will be separately described in detail.

### (Matching Integration Unit 160)

The matching integration unit 160 according to the present embodiment performs matching of feature points detected from the input image.

In addition, one of characteristics of the matching integration unit 160 is that the feature point matching is performed on the basis of the local feature generated on the basis of a pixel of a feature point and pixels around the feature point and the global feature generated on the basis of the entire pixels of the input image.

More specifically, the matching integration unit 160 may determine whether or not the feature point matching is successful on the basis of a combined feature obtained by combining the local feature and the global feature.

According to the characteristic of the matching integration unit 160 according to the present embodiment described above, it becomes possible to effectively reduce the influence of the repetitive pattern, lighting environment, weather, and the like, and to achieve more accurate feature point matching.

Note that the functions of the individual components including the matching integration unit 160 according to the present embodiment are implemented by various processors.

Details of the feature point matching according to the present embodiment will be separately described.

The first exemplary configuration of the information processing device 10 according to the present embodiment has been described above.

Note that, in the descriptions above, an exemplary configuration of a case where the information processing device 10 according to the present embodiment uses, as the global feature, the first global feature based on the image segmentation result alone has been described.

Meanwhile, the global feature according to the present embodiment is not limited to the first global feature.

Furthermore, the number of the global features according to the present embodiment is not limited to one.

The information processing device 10 according to the present embodiment may perform the feature point matching based on two or more global features.

For example, the global feature according to the present embodiment may include, in addition to the first global feature, a second global feature generated on the basis of a result of depth estimation performed on the input image.

Hereinafter, a second exemplary configuration will be described in which the information processing device 10 according to the present embodiment performs feature point matching based on the local feature, the first global feature, and the second global feature.

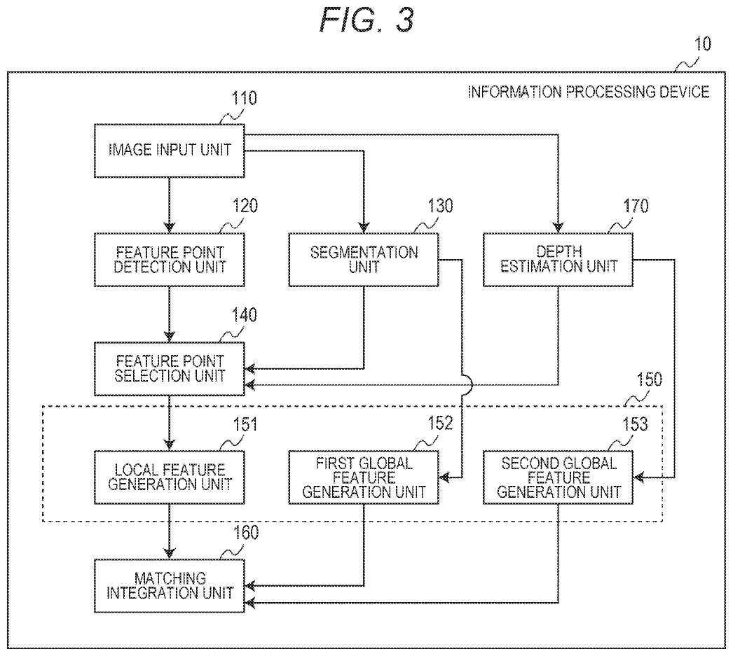

FIG. 3 is a block diagram illustrating the second exemplary configuration of the information processing device 10 according to the present embodiment.

Note that, hereinafter, descriptions will be given with a focus on a difference from the first exemplary configuration, and detailed descriptions of components, functions, and the like common to the first exemplary configuration will be omitted.

In the case of the second exemplary configuration, the information processing device 10 further includes a depth estimation unit 170 in addition to the individual components described in the first exemplary configuration.

The depth estimation unit 170 according to the present embodiment performs depth estimation on the input image.

The depth estimation according to the present embodiment is an exemplary process of generating a global feature.

Furthermore, the depth estimation according to the present embodiment may be a process based on estimation of a relative distance between pixels using a neural network including an encoder and a decoder.

In addition, in the case of the second exemplary configuration, the feature generation unit 150 further includes a second global feature generation unit 153 that generates a second global feature on the basis of a result of the depth estimation.

The depth estimation and the generation of the second global feature based on the result of the depth estimation according to the present embodiment will be separately described in detail.

The exemplary configurations of the information processing device 10 according to the present embodiment has been described above with reference to FIGS. 2 and 3.

As described above, the configuration of the information processing device 10 according to the present embodiment is flexibly modified depending on the type of the global feature and the number of the global features used for the feature point matching.

Note that, in the descriptions of the present embodiment above, an exemplary case where the global feature according to the present embodiment includes the first global feature generated on the basis of the image segmentation result and the second feature generated on the basis of the depth estimation result has been described.

However, the global feature according to the present embodiment is not limited to such an example, and the information processing device 10 may use another global feature in addition to or instead of the first feature and the second feature.

Examples of the another global feature include a feature based on a result of optical flow estimation.

In a case of using the feature based on the result of the optical flow estimation, the information processing device 10 may further include a component that performs the optical flow estimation and a component that generates a feature on the basis of a result of the estimation.

As described above, the configuration of the information processing device 10 according to the present embodiment may be flexibly modified depending on the type and number of the global features used for the feature point matching.

### 1.4. Functional Details

Next, details of the functions of the individual components included in the information processing device 10 according to the present embodiment will be described.

Note that, hereinafter, a case where the information processing device 10 according to the present embodiment conforms to the second exemplary configuration illustrated in FIG. 3 will be described as a main example.

### (Image Segmentation)

First, details of the image segmentation by the segmentation unit 130 according to the present embodiment will be described.

As described above, the image segmentation by the segmentation unit 130 according to the present embodiment may be multiclass segmentation.

The segmentation unit 130 according to the present embodiment estimates, on the basis of N classes defined in advance, a probability that each pixel in the input image corresponds to which class of the N classes, and estimates a class having the highest probability as a class of the corresponding pixel.

Examples of the class defined in the image segmentation according to the present embodiment include stationary objects and dynamic objects such as a road surface, a sidewalk, the sky, a pedestrian, a vehicle, a cyclist, a building, a plant, a guardrail, a utility pole, a sign, a traffic light, and the like.

Furthermore, the segmentation unit 130 according to the present embodiment divides the input image into a plurality of class regions on the basis of the class estimated for each pixel.

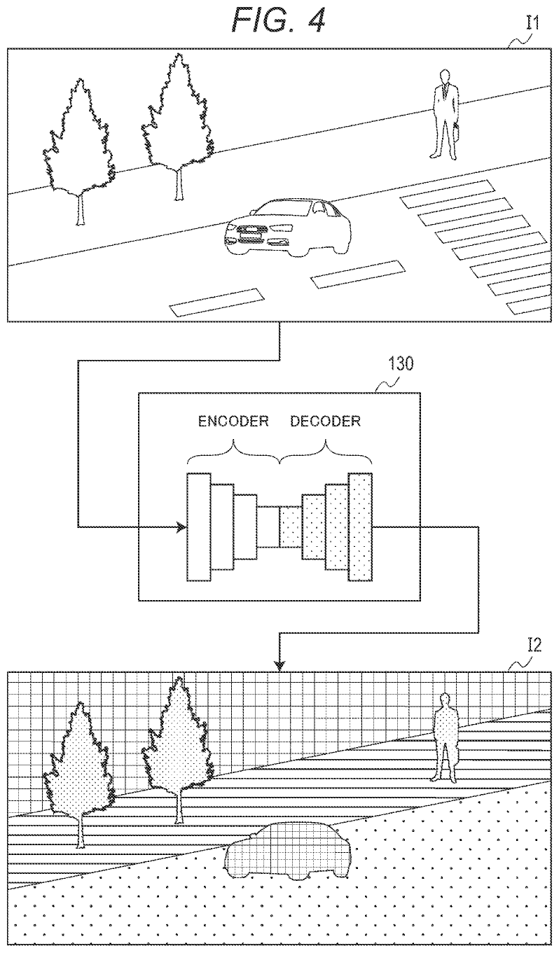

FIG. 4 is a diagram for explaining the image segmentation by the segmentation unit 130 according to the present embodiment.

The upper part of FIG. 4 illustrates an input image I1 in which objects such as a person, a vehicle, a plant, a sidewalk, a roadway, and the like appear.

As illustrated in the middle part of FIG. 4, the segmentation unit 130 according to the present embodiment inputs the input image I1 to a convolutional neural network including an encoder and a decoder.

As a result, the encoder generates a feature map with a plurality of resolutions, and the decoder estimates a class for each pixel.

The segmentation unit 130 according to the present embodiment is enabled to obtain an image I2 in which the region is divided for each class as illustrated in the lower part of FIG. 4 on the basis of a result of the class estimation of the class for each pixel by the decoder.

In a case of using a result of two-class segmentation for feature point selection, the feature points are concentrated on a partial region of the input image so that a distortion pattern of the feature points is biased, whereby the accuracy in the feature point matching may be deteriorated.

On the other hand, according to the multiclass segmentation by the segmentation unit 130 according to the present embodiment as described above, it becomes possible to avoid partial concentration of the feature points in the input image, and to improve the accuracy in the feature point matching.

### (Depth Estimation)

Next, the depth estimation by the depth estimation unit 170 according to the present embodiment will be described in detail.

The depth estimation unit 170 according to the present embodiment estimates a depth for each pixel from the input image.

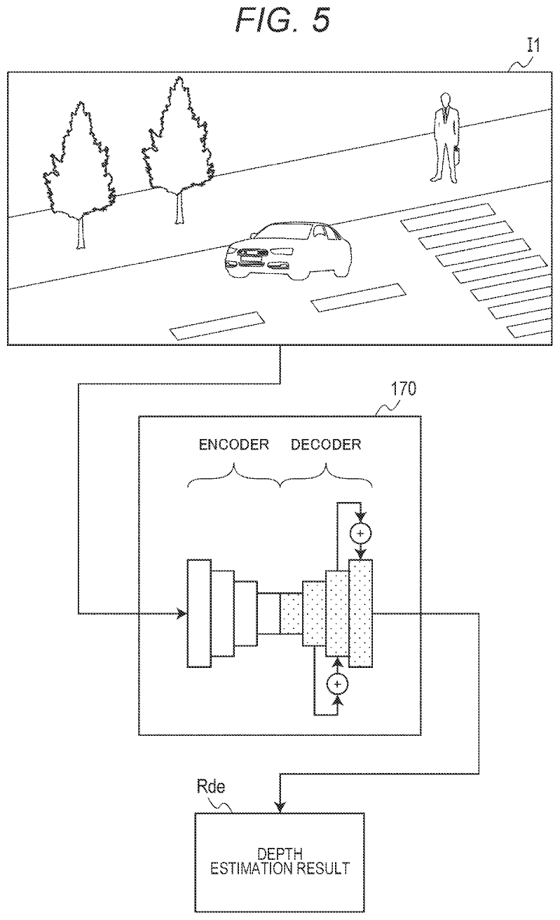

FIG. 5 is a diagram for explaining the depth estimation by the depth estimation unit 170 according to the present embodiment.

For example, as illustrated in FIG. 5, the depth estimation unit 170 according to the present embodiment may input the input image I1 to a neural network including an encoder and a decoder to obtain a depth estimation result Rde.

For example, an architecture disclosed in a document “Digging Into Self-Supervised Monocular Depth Estimation” (Clement Godard et al., 2019) may be used for the configuration of the neural network described above.

According to the architecture described above, it becomes possible to estimate a relative distance between pixels.

### (Feature Point Selection)

Next, the feature point selection by the feature point selection unit 140 according to the present embodiment will be described in detail.

The feature point selection unit 140 according to the present embodiment selects a target feature point to be subject to matching by the matching integration unit 160 from among the plurality of feature points detected from the input image on the basis of the image segmentation result and the depth estimation result.

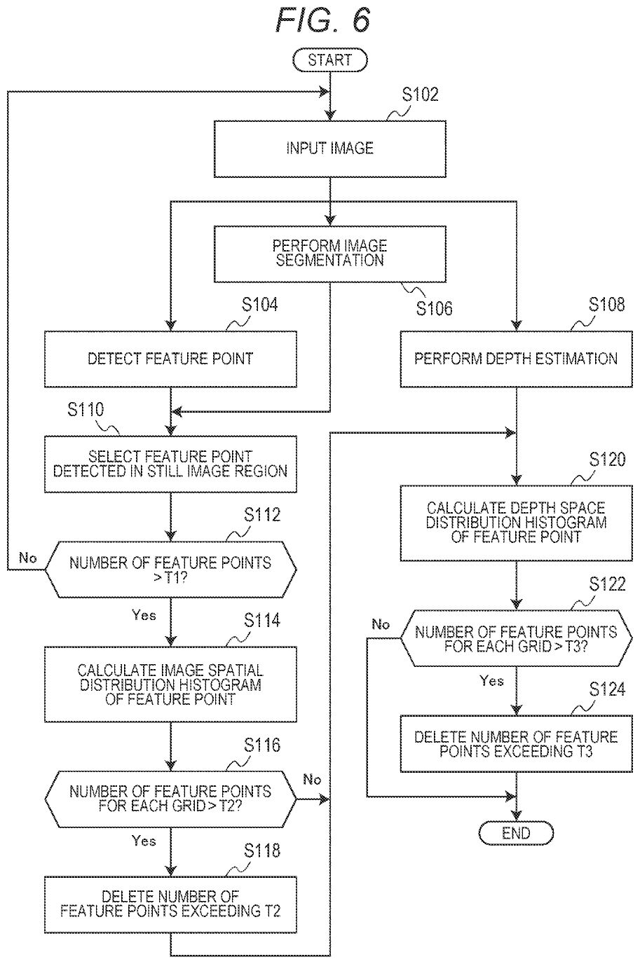

FIG. 6 is a flowchart for explaining a flow of automated selection of target feature points by the feature point selection unit 140 according to the present embodiment.

In the case of the example illustrated in FIG. 6, first, the image input unit 110 inputs an image captured by the camera 20 to the feature point detection unit 120, the segmentation unit 130, and the depth estimation unit 170 (S102).

The feature point detection unit 120 performs feature point detection on the basis of the input image (S104).

Furthermore, the segmentation unit 130 performs image segmentation on the basis of the input image (S106).

Furthermore, the depth estimation unit 170 performs depth estimation on the basis of the input image (S108).

The feature point selection unit 140 selects feature points detected in a still image region from among the feature points detected in step S104 on the basis of a result of the image segmentation in step S106 (S110).

Next, the feature point selection unit 140 determines whether or not the number of the feature points selected in step S110 is larger than a threshold T1 (S112).

Here, in a case where the number of the feature points selected in step S110 is equal to or smaller than the threshold T1 (No in S110), the information processing device 10 returns to step S102.

On the other hand, in a case where the number of the feature points selected in step S110 is larger than the threshold T1 (Yes in S110), the feature point selection unit 140 calculates an image spatial distribution histogram of the feature points (S114).

Specifically, the feature point selection unit 140 divides the image space corresponding to the input image into a plurality of grids, and distributes the individual feature points selected in step S110 on the basis of coordinates (x, y).

For example, in a case where the number of pixels in the width direction of the input image is represented by W, the number of pixels in the height direction of the input image is represented by H, the number of pixels in the width direction of the grid is represented by w, and the number of pixels in the height direction of the grid is represented by h, the number of grids may be obtained by the following equation (1).

$$\begin{matrix}[ Equation 1 ] & \\ M = ( floor ( \frac{W}{w} ) + 1 ) \times ( floor ( \frac{H}{h} ) + 1 ) & ( 1 )\end{matrix}$$

At this time, for example, indexes are given to M grids in a Z shape from the upper left to the lower right of the input image.

The feature point selection unit 140 calculates an image spatial distribution histogram by counting feature points for each of the grids set as described above.

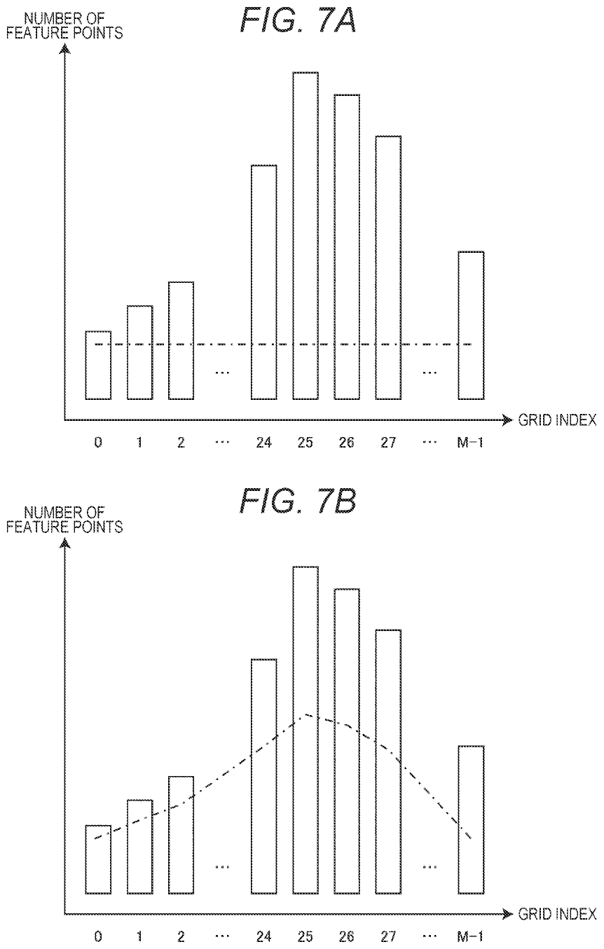

FIGS. 7A and 7B are examples of the image spatial distribution histogram according to the present embodiment.

In the image spatial distribution histogram illustrated in FIGS. 7A and 7B, the number of feature points included in each of the M grids to which the indexes 0 to M1 are given is illustrated.

The feature point selection unit 140 according to the present embodiment may select a target feature point on the basis of the image spatial distribution histogram as illustrated in the drawing.

For example, the feature point selection unit 140 may select only the same number of feature points as a threshold T2 determined in common for all the grids regardless of the grid position, and may delete the number of feature points exceeding the threshold T2.

In FIG. 7A, the threshold T2 determined in common for all the grids is indicated by a dash-dotted line.

On the other hand, the feature point selection unit 140 may select feature points using the threshold T2 determined according to the grid position in the input image.

In this case, the threshold T2 may be set larger for a grid closer to the center of the input image.

In FIG. 7B, the threshold T2 determined according to the grid position is indicated by a dash-dotted line. Note that, in FIG. 7B, it is assumed that the grids with the indexes 24 to 27 are relatively closer to the center of the input image.

Note that the threshold T2 may be set according to characteristics of distortion of the camera 20, usage scenes, and the like.

The selection of the target feature points based on the image spatial distribution histogram by the feature point selection unit 140 has been exemplified above.

The descriptions will continue again with reference to FIG. 6.

After calculating the image spatial distribution histogram of the feature points in step S114, the feature point selection unit 140 determines whether or not the number of feature points exceeds the threshold T2 for each grid (S116).

Here, in a case where there is a grid in which the number of feature points exceeds the threshold T2 (Yes in S116), the feature point selection unit 140 deletes the number of feature points exceeding the threshold T2 in the grid (S118).

On the other hand, in a case where there is no grid in which the number of feature points exceeds the threshold T2 (No in S116), the feature point selection unit 140 skips the processing of step S118.

Furthermore, the feature point selection unit 140 may also perform similar processing on a depth space.

In this case, the feature point selection unit 140 calculates a depth space distribution histogram of feature points (S120).

At this time, it is sufficient if a grid may be appropriately set according to a result of the depth estimation.

After calculating the depth space distribution histogram of the feature points in step S120, the feature point selection unit 140 determines whether or not the number of feature points exceeds a threshold T3 for each grid (S122).

Here, in a case where there is a grid in which the number of feature points exceeds the threshold T3 (Yes in S122), the feature point selection unit 140 deletes the number of feature points exceeding the threshold T3 in the grid (S124).

On the other hand, in a case where there is no grid in which the number of feature points exceeds the threshold T3 (No in S122), the feature point selection unit 140 skips the processing of step S124.

The flow of the feature point selection by the feature point selection unit 140 according to the present embodiment has been described above with an example.

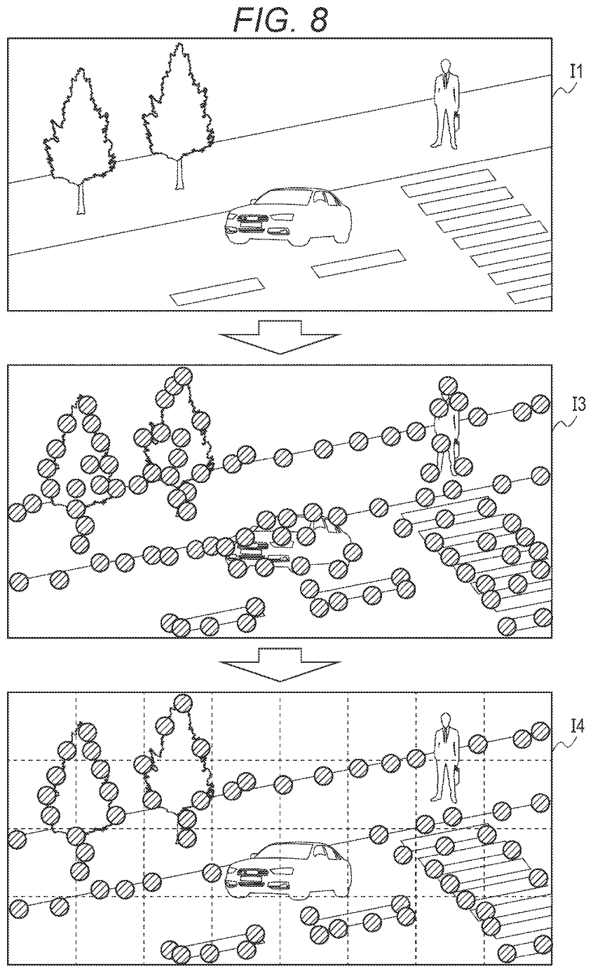

FIG. 8 is a diagram for explaining an effect of the feature point selection by the feature point selection unit 140 according to the present embodiment.

The upper part of FIG. 8 illustrates the input image I1, and the middle part of FIG. 8 illustrates an image I3 indicating a result of the feature point detection unit for the input image I1.

In the image I3, it can be seen that feature points are also detected in dynamic objects such as a person and a vehicle.

In addition, the lower part of FIG. 8 illustrates an image I4 in which target feature points are selected by the feature point selection unit 140.

Note that each grid is depicted using a dotted line in the image I4.

When the image I3 and the image I4 are compared with each other, it can be seen that the feature points related to dynamic objects, such as a person and a vehicle, have been deleted.

In this manner, it becomes possible to improve the accuracy in the feature point matching by deleting the feature points related to dynamic objects, such as a person and a vehicle, and selecting only the feature points related to stationary objects.

Furthermore, in the image I4, the number of feature points exceeding the threshold is deleted for each grid.

In this manner, by selecting the target feature points according to the threshold for each grid, it becomes possible to reduce the variation in the distribution of the target feature points in the image space and the depth space.

The automated selection of the target feature points by the feature point selection unit 140 according to the present embodiment has been described above.

Next, target feature point selection by the user will be described. The target feature points according to the present embodiment may be designated by the user.

In this case, the feature point selection unit 140 according to the present embodiment may present the result of the image segmentation performed on the input image to the user through a display, and may select target feature points from among the feature points on the basis of the segmentation region designated by the user.

Furthermore, the feature point selection unit 140 may superimpose the image segmentation result and the feature point detection result, and present them to the user.

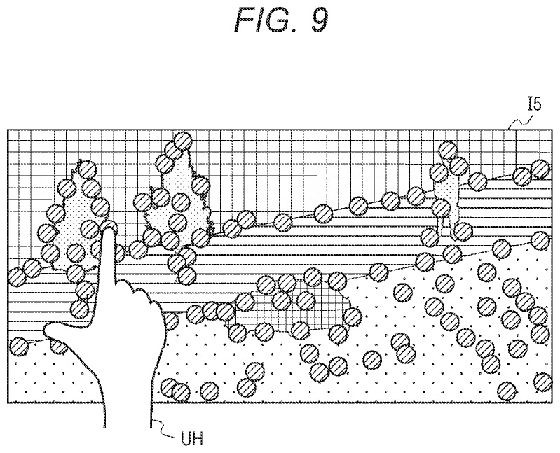

FIG. 9 is diagram for explaining the target feature point selection by the user according to the present embodiment.

FIG. 9 exemplifies an image I5 presented to the user on the basis of the control by the feature point selection unit 140.

The image I5 may be an image obtained by superimposing the image segmentation result or by superimposing the image segmentation result and the feature point detection result.

For example, the user designates any segmentation region or feature point using a finger UH on the presented image I5.

In the case of the example illustrated in FIG. 9, the user touches a feature point related to a plant with the finger UH.

In this case, the feature point selection unit 140 selects a target feature point from among the feature points detected in the segmentation region corresponding to the plant.

Note that the user may designate a segmentation region instead of a feature point.

Furthermore, designation may be performed by the user a plurality of times, and the feature point selection unit 140 may select a target feature point according to the designation by the user each time a feature point or a segmentation region is designated.

Furthermore, in a case where a feature point or a segmentation region related to a dynamic object, such as a person, a vehicle, or the like, is designated by the user, the feature point selection unit 140 may perform control such that notification such as “please reselect a non-moving object” is presented to the user.

According to the control as described above, the user is enabled to select a target feature point without bias while viewing the detected feature points and segmentation regions, which may improve the accuracy in the feature point matching.

### (Feature Generation)

Next, the feature generation by the feature generation unit 150 will be described in detail.

The feature generation unit 150 according to the present embodiment generates a feature for the target feature point selected by the feature point selection unit 140.

As described above, a feature according to the present embodiment includes a local feature generated on the basis of a pixel of a target feature point and an image (e.g., luminance) around the target feature point, and a global feature generated on the basis of the entire pixels of the input image.

A SIFT feature, an accelerated KAZE (AKAZE) feature, or the like may be adopted as the local feature.

Furthermore, examples of the global feature include the first global feature based on the image segmentation result and the second global feature based on the depth estimation result.

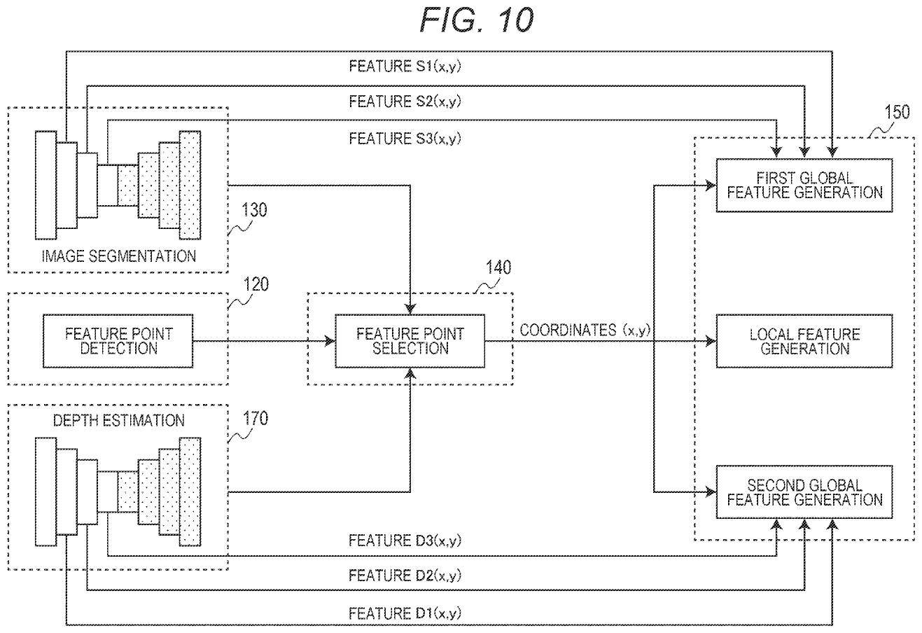

FIG. 10 is a diagram for explaining an outline of the feature generation by the feature generation unit 150 according to the present embodiment.

As illustrated in FIG. 10, a feature map of an encoder of a neural network is used to generate a global feature according to the present embodiment.

For example, in the case of the first global feature, features are combined on the basis of a plurality of feature maps having different resolutions in the encoder of the neural network used for the image segmentation and the coordinates of the selected target feature point (feature S1 (x, y), feature S2 (x, y), feature S3 (x, y)).

Similarly, in the case of the second global feature, features are combined on the basis of a plurality of feature maps having different resolutions in the encoder of the neural network used for the depth estimation and the coordinates of the selected target feature point (feature D1 (x, y), feature D2 (x, y), feature D3 (x, y)).

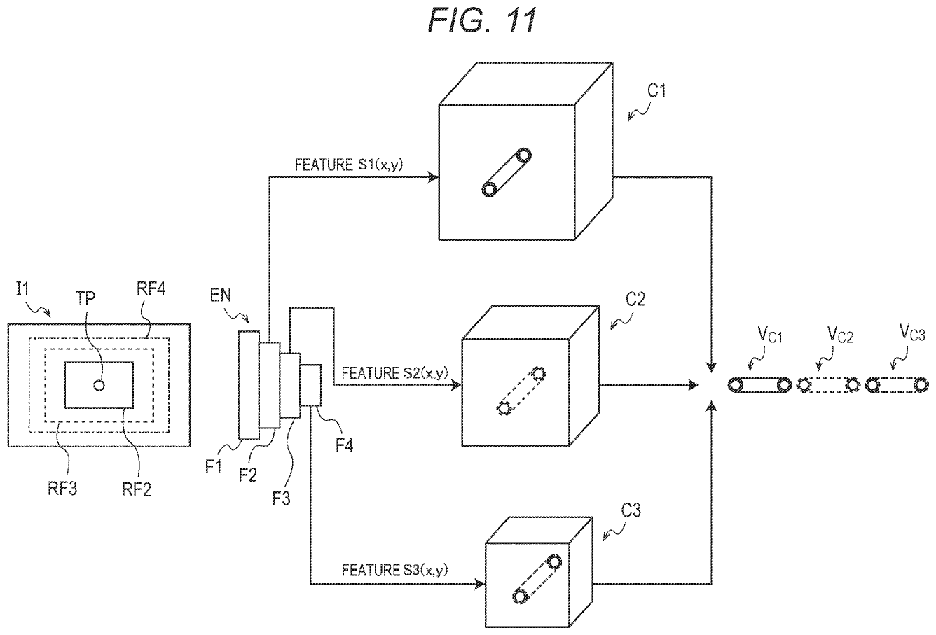

Next, generation of the global feature according to the present embodiment will be described in detail with reference to FIG. 11.

FIG. 11 is a diagram for explaining the global feature generation by the feature generation unit 150 according to the present embodiment.

FIG. 11 exemplifies a case where an encoder EN of the neural network used for processing of image segmentation, depth estimation, and the like has four feature maps F1 to F4.

Here, in a case where the resolution of the input image I1 is assumed to be W (width direction)×H (height direction), the resolutions of the feature maps F2 to F4 are 1/(s1*s1), 1/(s2*s2), and 1/(s3*s3), respectively, as compared with the resolution of the input image I1.

In view of the above, the feature maps F2 to F4 obtain characteristic information of pixels in a wider range by degrees from the input image I1, and receptive fields RFs 2 to 4, which correspond to the feature maps F2 to F4, respectively, gradually spread.

From the viewpoint described above, it can be said that the global feature according to the present embodiment reflects features of the composition and pattern of the entire input image I1, and is global with respect to the local feature.

Furthermore, a C1-dimensional vector V_{C1} in a channel direction of coordinates (x/s1, y, S1) on the feature map F2 corresponding to coordinates (x, y) of a target feature point TP is a feature obtained by determining the image segmentation result with respect to the coordinates (x, y) of the target feature point TP.

Similarly, a C2-dimensional vector V_{C2} in a channel direction of coordinates (x/s2, y, S2) on the feature map F3 corresponding to the coordinates (x, y) of the target feature point TP is a feature obtained by determining the image segmentation result with respect to the coordinates (x, y) of the target feature point TP.

Similarly, a C3-dimensional vector V_{C3} in a channel direction of coordinates (x/s3, y, S3) on the feature map F4 corresponding to the coordinates (x, y) of the target feature point TP is a feature obtained by determining the image segmentation result with respect to the coordinates (x, y) of the target feature point TP.

Therefore, the first global feature generation unit 152 and the second global feature generation unit 153 according to the present embodiment may use a set of the vectors V_{C1} to V_{C3} as the global feature.

That is, it can be said that the global feature according to the present embodiment includes the vectors in the channel direction corresponding to the coordinates of the feature points obtained from the plurality of individual feature maps with different resolutions included in the encoder EN.

Note that, in a case where x/S (S={s1, s2, s3}) is not an integer, the first global feature generation unit 152 and the second global feature generation unit 153 may obtain feature vectors in a channel direction of a plurality of integer coordinates close to x/S.

In this case, the global feature includes N sets of the vectors V_{C1} to V_{C3}.

Alternatively, the first global feature generation unit 152 and the second global feature generation unit 153 may perform bilinear sampling of feature vectors for a plurality of integer coordinates, generate a vector at one position, and set it as the global feature.

### (Feature Point Matching)

Next, the feature point matching by the matching integration unit 160 according to the present embodiment will be described in detail.

The matching integration unit 160 according to the present embodiment combines a local feature and a global feature to generate a combined feature.

In addition, the matching integration unit 160 according to the present embodiment learns the combined feature to perform feature point matching.

Hereinafter, two methods will be exemplified regarding the processing by the matching integration unit 160.

The first method is a method in which the matching integration unit 160 performs feature point matching by learning the generated combined feature independently of the learning related to the global feature generation (learning of image segmentation and learning of depth estimation).

That is, in the first method, learning related to global feature generation is carried out by a single task. Thereafter, a global feature is generated using the learned neural network, and a combined feature is generated from the global feature and a local feature. The matching integration unit 160 learns the generated combined feature for feature point matching.

On the other hand, the second method is a method in which the matching integration unit 160 performs feature point matching by learning, simultaneously with the learning related to the global feature generation (learning of image segmentation and learning of depth estimation), the combined feature obtained by combining the global feature generated from an intermediate result of the learning.

That is, in the second method, the learning related to the global feature generation, the generation of the combined feature, and the learning of the combined feature for feature point matching are simultaneously carried out (by multi-task).

First, the first method mentioned above will be described.

In the case of the first method, the matching integration unit 160 according to the present embodiment may generate a matching dictionary by accumulating combined features and label data in association with each other in a dictionary generation phase, and may perform feature point matching using the matching dictionary in a matching phase.

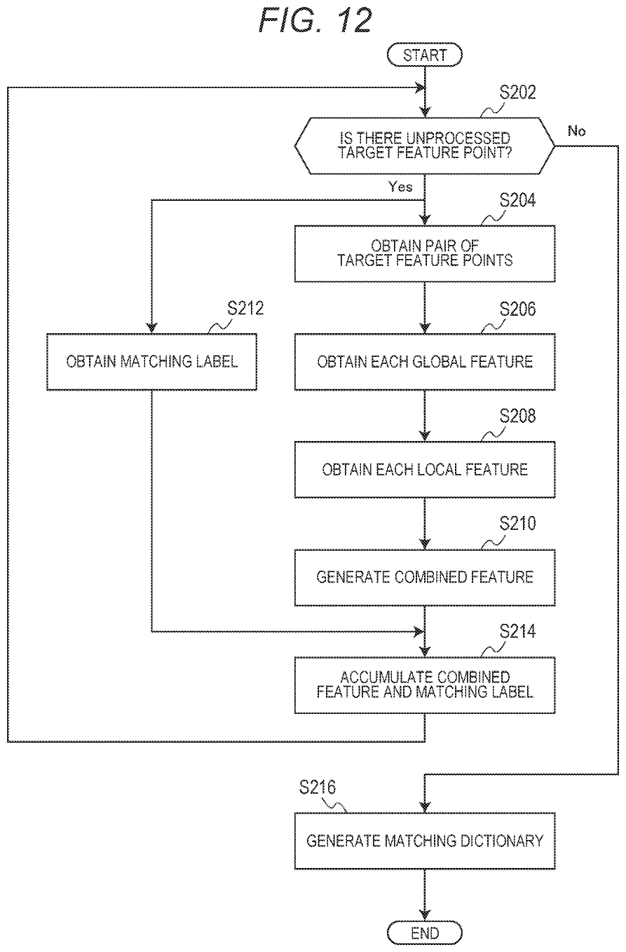

FIG. 12 is a flowchart for explaining a flow of the dictionary generation phase according to the present embodiment.

In the case of the example illustrated in FIG. 12, first, the matching integration unit 160 determines whether or not there is an unprocessed target feature point (S202).

In a case where there is an unprocessed target feature point (Yes in S202), the matching integration unit 160 obtains a pair of target feature points (S204).

The pair of target feature points may be a pair of the same feature points that has undergone visual confirmation by a person in a case of a positive example, and may be a pair of different feature points that has undergone visual confirmation by a person in a case of a negative example.

Next, the matching integration unit 160 obtains the global feature generated by the feature generation unit 150 for each of the pairs of target feature points (S206).

Furthermore, the matching integration unit 160 obtains the local feature generated by the feature generation unit 150 for each of the pairs of target feature points (S208).

Next, the matching integration unit 160 combines the global feature obtained in step S206 with the local feature obtained in step S208 to generate a combined feature (S210).

In a case where, in the combining described above, the global feature of the target feature point includes feature vectors in a channel direction of a plurality of coordinate positions instead of one coordinate, the feature vector is only required to be extended in predetermined order.

Furthermore, the matching integration unit 160 obtains a matching label related to the pair of target feature points (S212).

The matching label may be, for example, +1 in the pair of target feature points is a positive example, and may be −1 in a case where the pair of target feature points is a negative example.

Next, the matching integration unit 160 associates and accumulates the combined feature generated in step S210 and the matching label obtained in step S212 (S214), and returns to step S202.

The matching integration unit 160 repeats the processing of steps S202 to S214 until there is no unprocessed target feature point.

In a case where there is no unprocessed target feature point (No in S202), the matching integration unit 160 generates a matching dictionary on the basis of the matching labels and the combined features accumulated in step S214 (S216), and terminates the series of processing.

Note that the matching integration unit 160 may generate the matching dictionary using an algorithm such as a support vector machine (SVM). Alternatively, the matching integration unit 160 may make classification regarding whether the matching succeeds or fails using a multi-layer perception (MLP) neural network.

Next, a flow of the matching phase for matching feature points using the matching dictionary will be described.

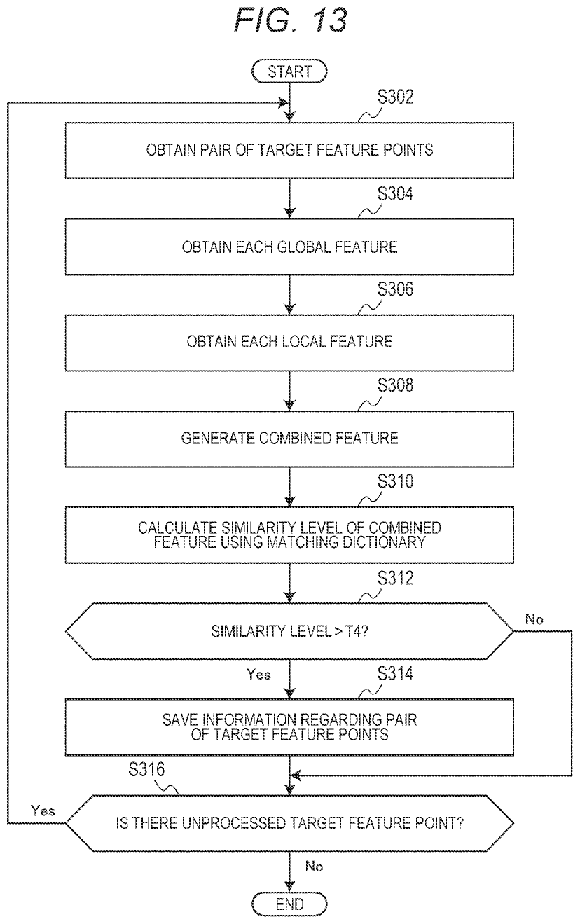

FIG. 13 is a flowchart for explaining the flow of the matching phase according to the present embodiment.

In the case of the example illustrated in FIG. 13, first, the matching integration unit 160 obtains a pair of target feature points (S302).

At this time, in a case where the numbers of target feature points selected in two target input images are N1 and N2, respectively, the total number of pairs of target feature points is N1*N2 at the maximum.

Next, the matching integration unit 160 obtains the global feature generated by the feature generation unit 150 for each of the pairs of target feature points (S304).

Furthermore, the matching integration unit 160 obtains the local feature generated by the feature generation unit 150 for each of the pairs of target feature points (S306).

Next, the matching integration unit 160 combines the global feature obtained in step S304 with the local feature obtained in step S306 to generate a combined feature (S308).

Next, the matching integration unit 160 calculates a similarity level of the combined feature for the pair of target feature points using the matching dictionary generated in the dictionary generation phase (S310).

Next, the matching integration unit 160 determines whether or not the similarity level calculated in step S310 exceeds a predetermined threshold T4 (S312).

In a case where the similarity level exceeds the threshold T4 (Yes in S312), the matching integration unit 160 determines that the matching related to the pair of target feature points is established, and saves information regarding the pair of target feature points (S314).

On the other hand, in a case where the similarity level is equal to or lower than the threshold T4 (No in S312), the matching integration unit 160 skips the processing of step S314.

Next, the matching integration unit 160 determines whether or not there is an unprocessed target feature point (S316).

In a case where there is an unprocessed target feature point (Yes in S316), the matching integration unit 160 returns to step S302 to repeatedly execute the subsequent processing.

On the other hand, in a case where there is no unprocessed target feature point (No in S316), the matching integration unit 160 terminates the series of processing.

Next, the second method mentioned above will be described.

In the case of the second method, the matching integration unit 160 carries out learning related to the feature point matching based on the combined feature by a multi-task learning method simultaneously with the learning related to the global feature generation (learning of image segmentation and learning of depth estimation).

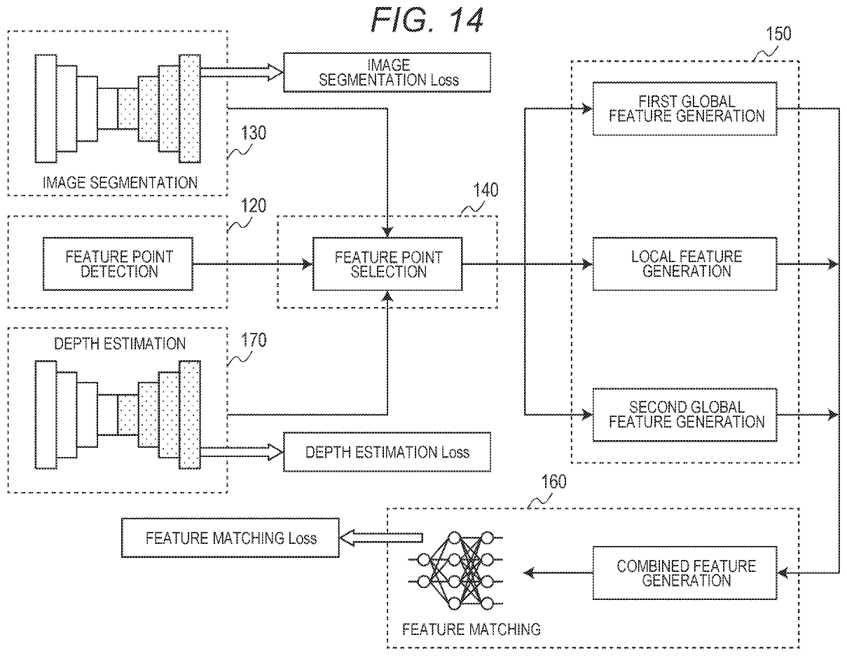

FIG. 14 is a diagram for explaining the multi-task learning according to the present embodiment.

A loss function in the multi-task learning according to the present embodiment may include an image segmentation loss calculated in the image segmentation by the segmentation unit 130, a depth estimation loss calculated in the depth estimation by the depth estimation unit 170, and a feature matching loss calculated in the feature matching by the matching integration unit 160.

Note that the matching integration unit 160 may calculate the feature matching and the feature matching loss using, for example, a multi-layer perception (MLP) neural network.

According to the multi-task learning as described above, it becomes possible to learn an effective feature in common in the three tasks of the image segmentation, the depth estimation, and the feature matching, whereby an effect of increasing the overall learning accuracy is expected.

More specifically, the loss function of the multi-task learning according to the present embodiment may be set as in the following equation (2), for example. In the equation (2), Segₗₒₛₛ, Depthₗₒₛₛ, and Matchingₗₒₛₛ represent the image segmentation loss, the depth estimation loss, and the feature matching loss, respectively.

$$\begin{matrix}[ Equation 2 ] & \\ {Total}_{loss} = {Seg}_{loss} + {Depth}_{loss} + {Matching}_{loss} & ( 2 )\end{matrix}$$

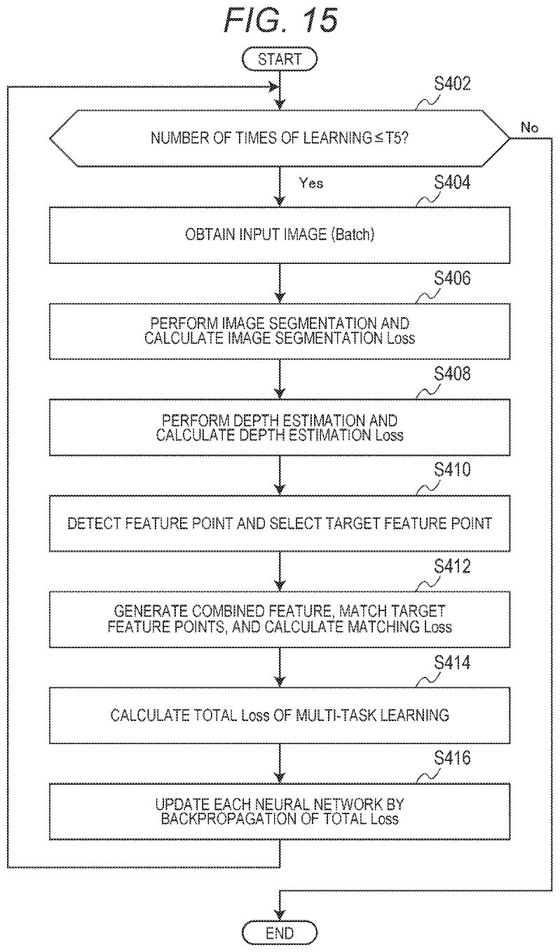

FIG. 15 is a diagram for explaining a flow of the multi-task learning according to the present embodiment.

In the case of the example illustrated in FIG. 15, first, the matching integration unit 160 determines whether or not the number of times of learning of the multi-task learning is equal to or less than a predetermined threshold T5 (S402).

In a case where the number of times of learning is equal to or less than the threshold T5, an input image or a plurality of pieces of input images (Batch) is obtained from the learning data (S404).

Next, image segmentation by the segmentation unit 130 is performed on the input image obtained in step S404, and an image segmentation loss is calculated (S406).

Furthermore, depth estimation by the depth estimation unit 170 is performed on the input image obtained in step S404, and a depth estimation loss is calculated (S408).

Next, feature point detection by the feature point detection unit 120, and target feature point selection by the feature point detection unit 120 reflecting a result of the image segmentation in step S406 are performed on the input image obtained in step S404 (S410).

Next, the feature generation unit 150 generates a local feature and a global feature, and the matching integration unit 160 generates a combined feature, matches target feature points based on the combined feature, and calculates a matching loss (S412).

At this time, the matching integration unit 160 inputs the combined feature to a neural network for matching to perform the feature point matching.

Next, the matching integration unit 160 calculates a total loss on the basis of the image segmentation loss calculated in step S406, the depth estimation loss calculated in step S408, and the matching loss calculated in step S410 (S414).

The matching integration unit 160 may calculate the total loss using the following equation (3).

$$\begin{matrix}[ Equation 3 ] & \\ {Total}_{loss} = {Seg}_{loss} * {exp}^{- {Seg}_{var}} + {Depth}_{loss} * {exp}^{- {Depth}_{var}} + {Matching}_{loss} * {exp}^{- {Matching}_{var}} + Sum ( abs ( {Seg}_{var} + {Depth}_{var} + {Matching}_{var} ) ) & ( 3 )\end{matrix}$$

In the case of using the equation (3), it is expected that the learning accuracy improves according to variations of lighting environment, weather, and the like at the time of image shooting with each loss component being dynamically weighted.

Note that, in the equation (3), a variable to which var is added is a learning target for setting the weight of each loss component, and the weight of each loss component is a calculation result multiplied by exp⁻( ).

The matching integration unit 160 updates each neural network by backpropagation of the total loss calculated as described above (S416).

As described above, the matching integration unit 160 according to the present embodiment calculates the total loss from the matching loss calculated by the neural network for matching and the loss calculated by the neural network used for the global feature generation.

Furthermore, the matching integration unit 160 according to the present embodiment updates the neural network for matching and the neural network used for the global feature generation by performing backpropagation of the total loss.

According to the multi-task learning as described above, it becomes possible to learn an effective feature in common in the three tasks of the image segmentation, the depth estimation, and the feature matching, whereby an effect of increasing the overall learning accuracy is expected.

After the processing of step S416, the matching integration unit 160 returns to step S402, and the multi-task learning is terminated in a case where the number of times of learning exceeds the threshold T5 (No in S402).

Next, a flow of the target feature point matching using each neural network that has performed learning by the multi-task learning will be described.

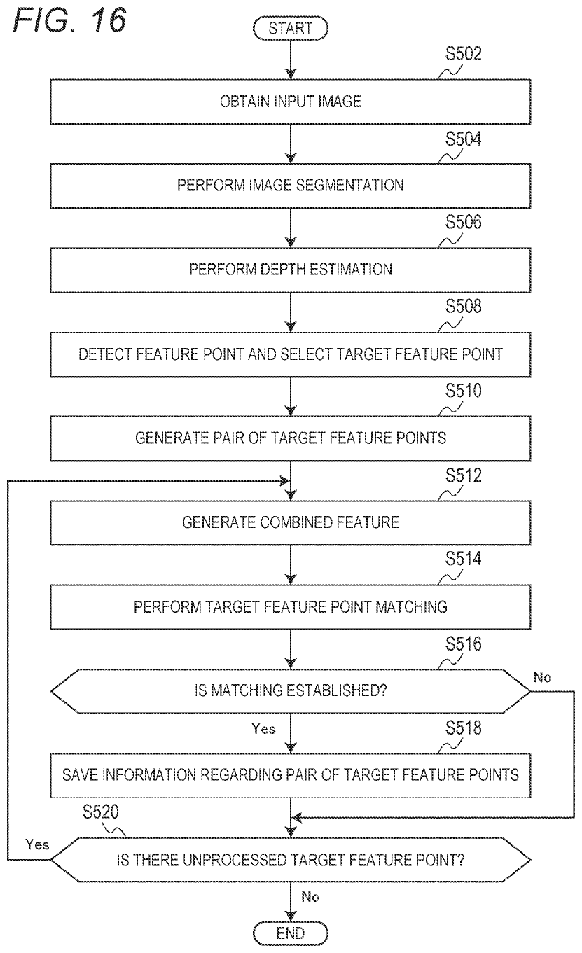

FIG. 16 is a flowchart for explaining a flow of the target feature point matching based on the multi-task learning according to the present embodiment.

In the case of the example illustrated in FIG. 16, first, two input images are obtained (S502).

Next, image segmentation by the segmentation unit 130 is performed on the input image obtained in step S502 (S504).

Furthermore, depth estimation by the depth estimation unit 170 is performed on the input image obtained in step S502 (S506).

Next, feature point detection by the feature point detection unit 120, and target feature point selection by the feature point detection unit 120 reflecting a result of the image segmentation in step S406 are performed on the input image obtained in step S404 (S508).

Next, the matching integration unit 160 creates a pair of target features from the target feature points in the respective input images obtained in step S502 (S510).

Next, the matching integration unit 160 generates a combined feature for each of the target feature points included in the pair created in step S510 (S512).

Next, the matching integration unit 160 inputs the two combined features generated in step S512 to the neural network for matching, and performs target feature point matching (S514).

Next, the matching integration unit 160 determines whether or not the matching in step S514 is established (S516).

A result of the matching in step S514 is two-class classification, which indicates establishment or non-establishment.

In a case where the matching in step S514 is established (Yes in S514), the matching integration unit 160 saves information regarding the pair of target feature points (S518).

On the other hand, in a case where the matching in step S514 is not established (Yes in S514), the matching integration unit 160 skips processing of step S518.

Next, the matching integration unit 160 determines whether or not there is an unprocessed target feature point (S520).

In a case where there is an unprocessed target feature point (Yes in S520), the matching integration unit 160 returns to step S512 to repeatedly execute the subsequent processing.

On the other hand, in a case where there is no unprocessed target feature point (No in S520), the matching integration unit 160 terminates the series of processing.

### 2. Exemplary Hardware Configuration

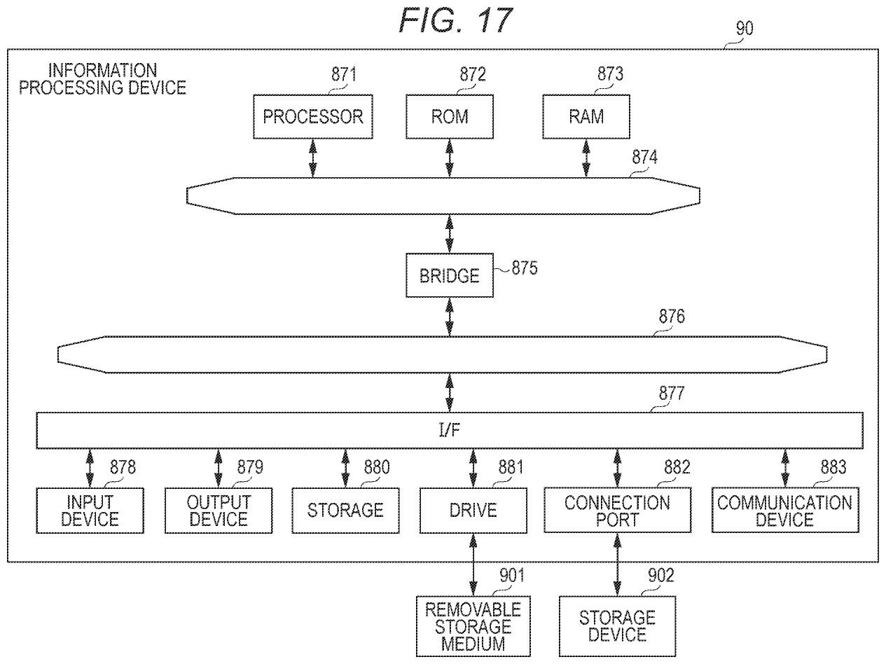

Next, an exemplary hardware configuration according to an embodiment of the present disclosure will be described. FIG. 17 is a block diagram illustrating an exemplary hardware configuration of an information processing device 90 according to the embodiment of the present disclosure. The information processing device 90 may be a device having a hardware configuration equivalent to that of the information processing device 10.

As illustrated in FIG. 17, the information processing device 90 includes, for example, a processor 871, a read-only memory (ROM) 872, a random access memory (RAM) 873, a host bus 874, a bridge 875, an external bus 876, an interface 877, an input device 878, an output device 879, a storage 880, a drive 881, a connection port 882, and a communication device 883. Note that the hardware configuration illustrated here is an example, and some of the components may be omitted. In addition, components other than the components illustrated here may be further included.

### (Processor 871)

The processor 871 functions as, for example, an arithmetic processing device or a control device, and controls the overall operation of each component or a part thereof on the basis of various programs recorded in the ROM 872, the RAM 873, the storage 880, or a removable storage medium 901.

### (ROM 872 and RAM 873)

The ROM 872 is a means for storing a program to be read into the processor 871, data to be used for calculation, and the like. The RAM 873 temporarily or permanently stores, for example, a program to be read into the processor 871, various parameters that appropriately change when the program is executed, and the like.

### (Host Bus 874, Bridge 875, External Bus 876, and Interface 877)

The processor 871, the ROM 872, and the RAM 873 are mutually connected via, for example, the host bus 874 capable of high-speed data transmission. Meanwhile, the host bus 874 is connected to the external bus 876 having a relatively low data transmission speed via the bridge 875, for example. Furthermore, the external bus 876 is connected to various components via the interface 877.

### (Input Device 878)

As the input device 878, for example, a mouse, a keyboard, a touch panel, a button, a switch, a lever, or the like is used. Moreover, as the input device 878, a remote controller (hereinafter referred to as a remote) capable of transmitting a control signal using infrared rays or other radio waves may be used. Furthermore, the input device 878 includes a voice input device such as a microphone.

### (Output Device 879)

The output device 879 is a device capable of visually or auditorily notifying the user of obtained information, such as a display device such as a cathode ray tube (CRT), a liquid crystal display (LCD), an organic electroluminescence (EL), or the like, an audio output device such as a speaker, a headphone, or the like, a printer, a mobile phone, a facsimile, or the like. Furthermore, the output device 879 according to the present disclosure includes various vibration devices capable of outputting a haptic stimulus.

### (Storage 880)

The storage 880 is a device for storing various types of data. As the storage 880, for example, a magnetic storage device such as a hard disk drive (HDD) or the like, a semiconductor storage device, an optical storage device, a magneto-optical storage device, or the like is used.

### (Drive 881)

The drive 881 is, for example, a device that reads information recorded in the removable storage medium 901 such as a magnetic disk, an optical disk, a magneto-optical disk, a semiconductor memory or the like, or writes information in the removable storage medium 901.

### (Removable Storage Medium 901)

The removable storage medium 901 is, for example, a digital versatile disc (DVD) medium, a Blu-ray (registered trademark) medium, an HD DVD medium, various semiconductor storage media, or the like. It is needless to say that the removable storage medium 901 may be, for example, an integrated circuit (IC) card on which a non-contact IC chip is mounted, an electronic device, or the like.

### (Connection Port 882)

The connection port 882 is a port for connecting an external connection device 902 such as a universal serial bus (USB) port, an IEEE 1394 port, a small computer system interface (SCSI), an RS-232C port, an optical audio terminal, or the like.

### (External Connection Device 902)

The external connection device 902 is, for example, a printer, a portable music player, a digital camera, a digital video camera, an IC recorder, or the like.

### (Communication Device 883)

The communication device 883 is a communication device for connecting to a network, and is, for example, a wired or wireless local area network (LAN), Bluetooth (registered trademark), a communication card for wireless USB (WUSB), a router for optical communication, a router for asymmetric digital subscriber line (ADSL), a modem for various types of communication, or the like.

### 3. Conclusion

As described above, the information processing device 10 according to the embodiment of the present disclosure includes the matching integration unit 160 that matches feature points detected from an input image. In addition, one of characteristics of the matching integration unit 160 according to the embodiment of the present disclosure is that the feature point matching is performed on the basis of the local feature generated on the basis of a pixel of a feature point and pixels around the feature point and the global feature generated on the basis of the entire pixels of the input image.

According to the configuration described above, it becomes possible to further improve the accuracy in the feature point matching.

While the preferred embodiment of the present disclosure has been described in detail with reference to the accompanying drawings, the technological scope of the present disclosure is not limited to such examples. It is obvious that those with ordinary skill in the technical field of the present disclosure may conceive various modifications or corrections within the scope of the technical idea described in the claims, and it is naturally understood that they also fall within the technical scope of the present disclosure.

Furthermore, individual steps related to the processes described in the present specification are not necessarily processed in time series in the order described in the flowcharts or the sequence diagrams. For example, individual steps related to the processes of individual devices may be processed in an order different from the described order, or may be processed in parallel.

Furthermore, the series of processing by each device described in the present specification may be implemented using any of software, hardware, or a combination of software and hardware.

The program included in the software is provided inside or outside each device, for example, and is stored in advance in a non-transitory computer readable medium.

Each program is read into the RAM at the time of execution by the computer, for example, and is executed by various processors.

The storage medium is, for example, a magnetic disk, an optical disk, a magneto-optical disk, a flash memory, or the like.

Furthermore, the program may be distributed via, for example, a network without using a storage medium.

Furthermore, the effects described in the present specification are merely exemplary or illustrative, and are not restrictive. In other words, the technology according to the present disclosure may produce other effects that are apparent to those skilled in the art from the description of the present specification, in combination with or instead of the effects described above.

Note that the following configurations also fall within the technological scope of the present disclosure.

(1)

An information processing device including:
a matching integration unit that performs matching of a feature point detected from an input image, in which
the matching integration unit performs the matching of the feature point on the basis of a local feature generated on the basis of a pixel of the feature point and pixels around the feature point and a global feature generated on the basis of entire pixels of the input image.
   (2)

The information processing device according to (1) described above, in which
the matching integration unit determines whether or not the matching of the feature points is successful on the basis of a combined feature obtained by combining the local feature and the global feature.
   (3)

The information processing device according to (2) described above, in which
the global feature includes a first global feature generated on the basis of a result of image segmentation performed on the input image.
   (4)

The information processing device according to (3) described above, in which
the image segmentation includes multiclass segmentation using a neural network including an encoder and a decoder.
   (5)

The information processing device according to any one of (2) to (4) described above, in which
the global feature includes a second global feature generated on the basis of a result of depth estimation performed on the input image.
   (6)

The information processing device according to (5) described above, in which
the depth estimation includes processing based on pixel relative distance estimation using a neural network including an encoder and a decoder.
   (7)

The information processing device according to (4) or (6) described above, in which
the global feature includes a vector in a channel direction corresponding to a coordinate of the feature point obtained from each of a plurality of feature maps with different resolutions included in the encoder.
   (8)

The information processing device according to any one of (2) to (7) described above, in which
the matching integration unit learns the combined feature to perform the matching of the feature points.
   (9)

The information processing device according to (8) described above, in which
the matching integration unit generates a matching dictionary by accumulating the combined feature and label data in association with each other in a dictionary generation phase, and performs the matching of the feature points using the matching dictionary in a matching phase.
   (10)

The information processing device according to (8) described above, in which
the matching integration unit simultaneously learns learning related to generation of the global feature and learning related to the matching of the feature points based on the combined feature by a multi-task learning method.
   (11)

The information processing device according to (10) described above, in which
the matching integration unit inputs the combined feature to a neural network for matching to perform the matching of the feature points.
   (12)

The information processing device according to (11) described above, in which
the matching integration unit calculates a total loss from a matching loss calculated by the neural network for matching and a loss calculated by a neural network used for the generation of the global feature, and performs backpropagation of the total loss to update the neural network for matching and the neural network used for the generation of the global feature.
   (13)

The information processing device according to any one of (1) to (12) described above, further including:
a feature point selection unit that selects a target feature point to be subject to the matching from among a plurality of the feature points detected from the input image.
   (14)

The information processing device according to (13) described above, in which
the feature point selection unit selects the target feature point from among the feature points detected in a still image region determined as a stationary object in the input image.
   (15)

The information processing device according to (13) or (14) described above, in which
the feature point selection unit selects the target feature point on the basis of an image spatial distribution histogram of the feature points detected from the input image.
   (16)

The information processing device according to any one of (13) to (15) described above, in which
the feature point selection unit selects the target feature point on the basis of a depth space distribution histogram of the feature points detected from the input image.
   (17)

The information processing device according to (13) described above, in which
the feature point selection unit presents a result of image segmentation performed on the input image to a user, and selects the target feature point on the basis of a segmentation region designated by the user.
   (18)

The information processing device according to any one of (1) to (17) described above, in which
the information processing device is mounted on a mobile object.
   (19)

An information processing method including:
performing, with a processor, matching of a feature point detected from an input image, in which
the performing the matching further includes performing matching of the feature point on the basis of a local feature generated on the basis of a pixel of the feature point and pixels around the feature point and a global feature generated on the basis of entire pixels of the input image.
   (20)

A program for causing a computer to function as an information processing device including:
a matching integration unit that performs matching of a feature point detected from an input image, in which
the matching integration unit performs the matching of the feature point on the basis of a local feature generated on the basis of a pixel of the feature point and pixels around the feature point and a global feature generated on the basis of entire pixels of the input image.

### REFERENCE SIGNS LIST

10 Information processing device
110 Image input unit
120 Feature point detection unit
130 Segmentation unit
140 Feature point selection unit
150 Feature generation unit
151 Local feature generation unit
152 First global feature generation unit
153 First global feature generation unit
160 Matching integration unit
170 Depth estimation unit
20 Camera
30 Mobile object

1. An information processing device comprising:
a matching integration unit that performs matching of a feature point detected from an input image, wherein
the matching integration unit performs the matching of the feature point on a basis of a local feature generated on a basis of a pixel of the feature point and a pixel around the feature point and a global feature generated on a basis of entire pixels of the input image.

2. The information processing device according to claim 1, wherein
the matching integration unit determines whether or not the matching of the feature point is successful on a basis of a combined feature obtained by combining the local feature and the global feature.

3. The information processing device according to claim 2, wherein
the global feature includes a first global feature generated on a basis of a result of image segmentation performed on the input image.

4. The information processing device according to claim 3, wherein
the image segmentation includes multiclass segmentation using a neural network including an encoder and a decoder.

5. The information processing device according to claim 2, wherein
the global feature includes a second global feature generated on a basis of a result of depth estimation performed on the input image.

6. The information processing device according to claim 5, wherein
the depth estimation includes processing based on pixel relative distance estimation using a neural network including an encoder and a decoder.

7. The information processing device according to claim 4, wherein
the global feature includes a vector in a channel direction corresponding to a coordinate of the feature point obtained from each of a plurality of feature maps with a different resolution included in the encoder.

8. The information processing device according to claim 2, wherein
the matching integration unit learns the combined feature to perform the matching of the feature point.

9. The information processing device according to claim 8, wherein
the matching integration unit generates a matching dictionary by accumulating the combined feature and label data in association with each other in a dictionary generation phase, and performs the matching of the feature point using the matching dictionary in a matching phase.

10. The information processing device according to claim 8, wherein
the matching integration unit simultaneously learns learning related to generation of the global feature and learning related to the matching of the feature point based on the combined feature by a multi-task learning method.

11. The information processing device according to claim 10, wherein
the matching integration unit inputs the combined feature to a neural network for matching to perform the matching of the feature point.

12. The information processing device according to claim 11, wherein
the matching integration unit calculates a total loss from a matching loss calculated by the neural network for matching and a loss calculated by a neural network used for the generation of the global feature, and performs backpropagation of the total loss to update the neural network for matching and the neural network used for the generation of the global feature.

13. The information processing device according to claim 1, further comprising:
a feature point selection unit that selects a target feature point to be subject to the matching from among a plurality of the feature points detected from the input image.

14. The information processing device according to claim 13, wherein
the feature point selection unit selects the target feature point from among the feature points detected in a still image region determined as a stationary object in the input image.

15. The information processing device according to claim 13, wherein
the feature point selection unit selects the target feature point on a basis of an image spatial distribution histogram of the feature points detected from the input image.

16. The information processing device according to claim 13, wherein
the feature point selection unit selects the target feature point on a basis of a depth space distribution histogram of the feature points detected from the input image.

17. The information processing device according to claim 13, wherein
the feature point selection unit presents a result of image segmentation performed on the input image to a user, and selects the target feature point on a basis of a segmentation region designated by the user.

18. The information processing device according to claim 1, wherein
the information processing device is mounted on a mobile object.

19. An information processing method comprising:
performing, with a processor, matching of a feature point detected from an input image, wherein
the performing the matching further includes performing matching of the feature point on a basis of a local feature generated on a basis of a pixel of the feature point and a pixel around the feature point and a global feature generated on a basis of entire pixels of the input image.

20. A program for causing a computer to function as an information processing device comprising:
a matching integration unit that performs matching of a feature point detected from an input image, wherein
the matching integration unit performs the matching of the feature point on a basis of a local feature generated on a basis of a pixel of the feature point and a pixel around the feature point and a global feature generated on a basis of entire pixels of the input image.
